(19) United States
(12) Patent Application Publication
(10) Pub. No.: US 2015/0356090 A1
(43) Pub. Date: Dec. 10, 2015

(54) System and Method for Dynamically Constructing Theatrical Experiences from Digital Content

(71) Applicant: Northwestern University, Evanston, IL (US)

(72) Inventors: Lawrence Birnbaum, Evanston, IL (US); Kristian John Hammond, Chicago, IL (US); Patrick McNally, Sunnyvale, CA (US); Jason Cohn, Chicago, IL (US); Rachel Birnbaum, Evanston, IL (US)

(21) Appl. No.: 14/734,872

(22) Filed: Jun. 9, 2015

Related U.S. Application Data
(60) Provisional application No. 62/009,495, filed on Jun. 9, 2014.

(51) Int. Cl. G06F 17/30

(52) U.S. Cl. CPC G06F 17/3053; G06F 17/30477; G06F 17/30442

(57) ABSTRACT

A system and method can automatically and dynamically construct scripts for live theatrical experiences from online content by automatically forming and managing queries and filters to retrieve and select appropriate content from a variety of online sources, and assembling the content so identified in order to produce interesting theatrical experiences. The resulting scripts can be relayed dynamically to actors for presentation in live theatrical performances.

### CROSS-REFERENCE TO RELATED APPLICATIONS

This patent application claims the benefit of U.S. Provisional Patent Application No. 62/009,495, filed on Jun. 9, 2014, the entire contents of which is incorporated by reference in its entirety.

### STATEMENT OF U.S. GOVERNMENT SUPPORT

This invention was made with government support under IIS0856058 and IIS0917261 awarded by the National Science Foundation. The government has certain rights in the invention.

### BACKGROUND

The various and ever-increasing quantity and quality of widely available, computer-manipulable content, e.g., online content, creates an opportunity to automatically generate engaging narrative or theatrical experiences using this content. Due to the diversity and dynamic nature of online content, much of it user-generated by people other than professional content creators, the experiences can be made unique and ever-changing, localized, and even personalized. Drawing content from social media, blogs, and a wide variety of online discussion forums, the users can present authentic voices from a community as part of a larger narrative structure that provides direction, purpose, and context, creating a meaningful whole from the individual content items selected and combined.

### BRIEF DESCRIPTION OF DRAWINGS

FIG. 1 is a block diagram of an example system architecture for script generation.

FIG. 2 is a block diagram of an example flow logic of the system architecture of FIG. 1.

FIG. 3 is a flow diagram of an example presentation mechanism.

### DESCRIPTION

The systems and methods can provide for dynamically constructing scripts for live theatrical experiences from online content by automatically forming and managing queries and filters to retrieve and filter such content, assembling the resulting content into scripts, and delivering the resulting scripts to actors in real time for presentation to audiences in live theatrical performances. Additionally or alternatively, the content may be stored offline. The generated scripts can also be used with other types of media including but not limited to books, movies, etc.

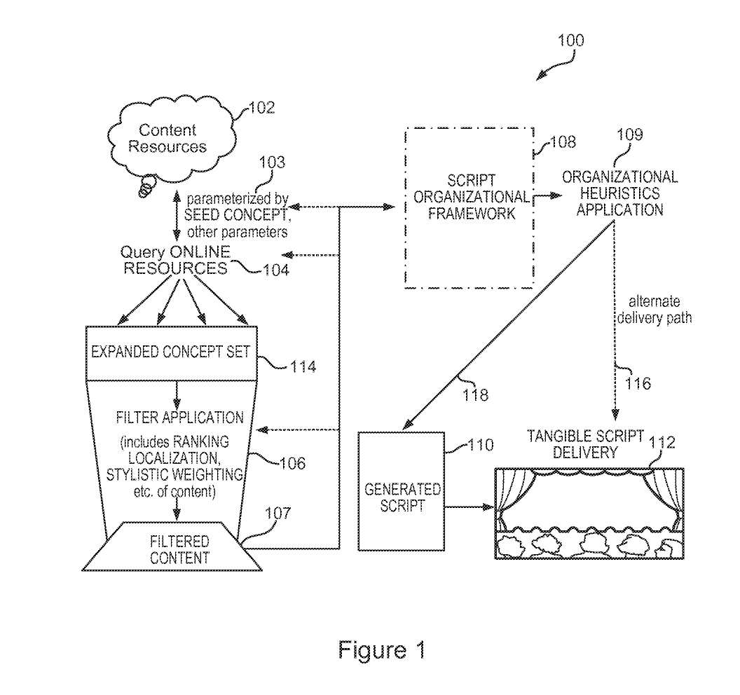

FIG. 1 is a block diagram of an example system architecture 100 for script generation. A script generation engine collects and organizes content from a potentially a wide variety of online sources 102, including social media, blogs, online forums, etc. The engine can utilize parameters in the search, for example parameters that invoke themes, topical terms, concepts, tonalities, locations, locales, etc., which may be desired in the final theatrical script. Additionally or alternatively, the parameters can include content extracted from material returned by previously executed queries, including names, locations, terms or phrases, etc. In some implementations, a human curator can supply the parameters to the system 100 for processing. The parameters can also include seed content 103, e.g., “whimsy”, “anger”, “love”, etc. The system 100 generates scripts from materials collected during the search or searches. The script can be produced of words, phrases, dialog, images, etc.

The system architecture 100 includes a set of queries 104 and filters 106, which can be determined ahead of time based on the organizing narrative structure, e.g., script organization framework 108 or model. The resulting content from the queries 104 and filters 106 can be organized into the script or other presentation according to a narrative structure and/or script organizational framework 108 to produce the script 110 and provide tangible script delivery 112. In one implementation, the narrative structure can organize the material for the script by reference to venues and/or common occurrences in a time period or event. The system 100 can also edit the material, e.g., by changing place names, names of people, etc. The system 100 used sources for the material may be determined ahead of time, or they may be provided via parameters from the curator, etc.

As noted above, script generation may be parameterized by the seed concepts 103 (e.g., “anger”, “science fiction”, “love”, “whimsy”, etc.), which determine the script's overall content and domain or domains. For example a query may include the parameter seed+the string “your mother.” Given the seed “love” or “Chicago” this would lead to searches for content including the terms “love your mother,” “Chicago your mother,” etc. In one implementation a human curator can supply the parameters to the system 100. The curator may also specific additional constraints, such as preferred location, tonality (e.g., personal, profane, etc.), and other constraints, which may be used to determine either sources to be utilized, or incorporated into queries 104 or filters 106 as appropriate.

The script generation engine issues the specified queries, potentially incorporating the seed concept 103 or other parameters, to various publicly accessible online resources. Content retrieved in this way constitutes an expanded concept set 114. The following computer code, written in Python, illustrates one possible implementation of this process:

def grab_and_validate_args( ):

if len(sys.argv)!=2:

print “Please enter a word”

raise SystemExit

global SEED_CONCEPT

SEED_CONCEPT=sys.argv[1]

grab_and_validate_args( )

for resource in ONLINE RESOURCES:

resource_content=resource.query(SEED_CONCEPT)

EXPANDED_CONCEPT_SET.add(resource_content)

scriptIt.generate_script(EXPANDED_CONCEPT_SET, SEED_CONCEPT)

The queries specified by the system 100 may be executed all at once (as is the case in the code provided above) with the resulting content subsequently being filtered and then finally organized for presentation according to the narrative structure (script organizational framework). Alternatively, the queries and filters may be applied incrementally, in the order specified by the narrative/script organizational structure, with the incremental results being incorporated into the script or presentation as they are produced. The second approach supports an extended model in which content retrieved, filtered, and incorporated at one point in the process, e.g., names, locations, or other terms or phrases contained in or derived from this content, may be used to parameterize queries or filters to be used later in the process, providing additional constraints that may improve continuity or fluency of the resulting script.

As described, the system 100 also specifies a variety of filters 106, including methods for stylistic weighting and localization, to the results of the queries (expanded concept set). These filters 106 may assess content on the basis of its length, how personal it is (as indicated by the presence of first and second person pronouns, or relationship terms such as “boyfriend” or “mother”, etc.), its sentiment, profanity, and/or other pragmatic features. The results may be used to rank and select the content resulting from the queries. The system 100 can utilize other pragmatic features during the script generation, including but not limited to a level of positive or negative sentiment of the material. The system 100 can modulate a level of the pragmatic features throughout the script, e.g., by increasing or decreasing the level that the pragmatic features change the script.

The following computer code again illustrates a possible implementation of this notion:

global pronouns

pronouns=(“i”,“me”,“us”,“my”,“our”,“we”,“his”,“her”,“he”,“she”,“i've”,

“we've”, “she's”,“he's”)

pronounSet=set(pronouns)

global relationships

relationships=)‘boy’,‘girl’,‘friend’,‘friends’,‘lover’,‘wife’,‘husband’,‘mom’,‘dad’,

‘mother’,‘father’,‘son’,‘daugther’,‘kid’,‘child’,‘parent’,‘parents’,‘clidren’,‘boss’,

‘buddy’, ‘bf’,‘bff’,‘gf’)

relationshipSet=set(relationships)

# personal_test calculates the number of personal pronouns in the text.

def personal_test(Text):

Text[“PersonalN”]=len(pronounSet.intersection(Text[“TokenSet”]))

return Text[“PersonalN”]>0

# relationship_test calculates the number of relationships words in the text.

def relationship_test(Text):

Text[“RelationshipN”]=len(relationshipSet.intersection(Text[“TokenSet”]))

return Text[“RelationshipN”]>0

# a good answer has to be personal and the right size.

def filter good answers(answers):

filtered=[ ]

for answer in answers:

if answer[“Fits”] and (answer[“PersonalBool”] or answer[“RelationshipBool”]):

filtered.append(answer)

return filtered

# A dirty answer has to have two pieces of profanity and be fairly short.

def filter_dirty_answers(answers):

filtered=[ ]

for answer in answers:

if answer[“Length”]<25 and (answer[“DirtyScore”]>1):

filtered.append(answer)

return filtered

Once appropriate content has been retrieved and filtered, organizational heuristics 109 informed by the narrative structure, or script organizational framework 108, can be used to order and format the filtered content, delivering the resulting script line-by-line to the actors as it is being generated (116), or alternatively caching it in a script for subsequent presentation (118). In either approach, the actors' lines can be delivered to them in real time, during the performance, via the presentational mechanism described in the next section. This organization may be imposed after all the content has been retrieved and filtered, or incrementally, as described earlier. The following code again provides an illustration of one possible implementation of this process:

def say_title(question):

output(next( ), “Title: “+question[“Title”][“Clean”],””)

def dialog(question):

global player

output(next( ),question[“Title”][“Text”],“PAUSE”)

line_feed( )

output(player,question[“Question”][“Text”],“Personal question!”)

line_feed( )

present_answers(question[“Answers”],player)

def say_snarky(definitions,topic):

for definition in definitions:

if definition[“Definition”][“SnarkyScore”]>0:

output(next( ),topic+“:”+definition[“Definition”][“Clean”],””)

line_feed( )

In addition to queries 104 and filters 106, the system 100 may specify a variety of editing processes to be used to develop the final content for inclusion in the script and presentation to the audience. These may include, for example, the substitution of certain place names or locations for others (e.g., “Los Angeles” may become “Chicago”, or “the Tube” may become “the Subway”); the substitution of one proper name for another; changing the gender of certain pronouns; deleting or inserting profanity; replacing terms with synonyms; editing for length; etc. Additionally or alternatively, the edits can include selecting subsets of the query results, e.g., selecting only female family members from the results, etc.

Therefore, on the Computer Science side the system 100 can provide automatic content generation through the assembly of online content, for example as in the News at Seven project (Nichols, et al., 2009), which is incorporated by reference in its entirety herein. In the system 100, online content can be retrieved, filtered, and assembled to meet the rhetorical goals of a larger narrative structure, and then presented using text-to-speech technology voiced by animated characters. For example, the system is capable of constructing a “Siskel and Ebert”-style back-and-forth discussion about a movie, in which one character praises the movie, and the other criticizes it. The dialog about a given movie is generated by selecting textual snippets from positive and negative reviews, as well as other information about the movie, found in online sources. Its rhetorical coherence is derived from the back-and-forth nature of a polarized conversation—e.g., one character delivers a positive snippet, and then the other delivers a negative snippet. The selection process is additionally informed or constrained by a taxonomy of movie aspects or topics, acting, story, direction, etc. Hence if a snippet is found that criticizes the acting (to be voiced by the negative character), the system 100 then tries to find another review praising the acting (to be voiced by the positive character), or, failing that, change the subject to a different aspect of the movie for which a positive snippet can be found. Texts are additionally augmented by the use of introductory “interstitial” comments, such as, “I couldn't disagree more.”

On the theater side, the system 100 draws on an experimental production at Northwestern University based on a script “written” by manual curation, in which the human author constructed the script by selecting and ordering excerpts from the Craig's List forum “Missed Connections” (Young Hearts Be Free Tonight, by Rachel Birnbaum).

The system 100 combines these Computer Science and theater concepts. Rather than human selection, editing, and ordering of online content, the system 100 utilizes machine curation. Rather than presentation via animated characters and text-to-speech, the lines can be delivered by human actors. The scripts are automatically and dynamically assembled, and then presented to the actors in real time during each performance.

Script delivery 112 can use large screens to present the actors with their lines, with the timing being controlled by a director/stage manager. The shows can include multiple segments, each five to ten minutes long. For example, one segment can use snippets from the Craig's List forum “Missed Connections,” interleaved with reviews from Yelp. This segment can be organized temporally by utilizing posts involving venues associated with particular times of day. The system 100 searches first for posts that mentioned a coffee shop, and then public transportation (morning); then a health club (afternoon); then a restaurant, and finally a bar or club (evening). These posts are then presented in the same order, interspersed with reviews of those venues. Another segment can search the online discussion site Reddit for arguments, of appropriate length, between two people, and then present an appropriate number of these. Yet another segment of the show can present relationship problems and advice, which can again be sourced from Reddit.

The production can utilize personal and wearable information display/“augmented reality” devices, e.g., glasses including Google Glass, to present the actors with their lines. In this implementation, the actors can control the timing of the presentation of their lines themselves using these devices. The narrative arc, e.g., script organizational framework described above, or can be inspired by a number of theatrical improvisation games. For example, given an initial seed concept 103, e.g., term or phrase, e.g., “science fiction,” the system 100 can retrieve online dictionary definitions (first from a standard source, and from the Urban Dictionary, a source likely to provide a “nonstandard” definition). The system 100 can also use the seed concept 103 as a query to retrieve entries and associated comments on that topic from the online discussion forum Yahoo! Answers. The entries and comments so retrieved are then assessed and filtered for such properties as length, neither too long nor too short; how personal they are (as measured, e.g., by the density of first and second person pronouns in the text, and/or by the prevalence of relationship terms such as “friend” or “wife”), and more personal items may be preferred; profanity, and more profane comments may be preferred as the scene progresses; etc. The definitions, chosen entries and comments on those entries, etc., retrieved and filtered are then ordered and presented to the actors in real time for delivery to the audience.

Basic System Architecture and an Example

First, an overall narrative structure (script organizational framework) can be determined for the script. This specifies the nature of the content and how it is be arranged. For example, the structure of a script based on “Missed Connections” may be built around a day. (In one narrative structure: to track one or more people through a fixed time period, such as a day, or an event, such as a party, using the standard structure of that sequence as an organizing principle for the narrative.) This structure is then implemented in terms of a series of queries and filters that identifies appropriate online content for each portion of the narrative structure.

In this instance, for example, the system 100 can first find posts to the “Missed Connections” forum that refer or relate in some way to particular times or standard milestones in a day, such as the morning, commuting, the workday, exercising, dinner, etc., using queries designed to identify such posts. These queries typically include sets of words or phrases, which may be determined ahead of time, or which may be supplied as parameters, associated with the activities or topics of interest. By using the queries, the system 100 can identify content relevant to particular portions of the narrative structure. The system 100 can also filter the resulting content. For example, content that is too terse or too long may be eliminated. Filtering is done by first tagging the retrieved content based on certain properties, e.g., length, sentiment, degree of “personal content,” degree of profanity, etc. Thus, for example, in addition to finding and ordering content based on time of day, the system 100 may also be configured to prefer increasing levels of sexual content in the posts it selects relevant to the different portions of the day.

Depending on the nature of the desired script, different sources of online content can be utilized, and multiple sources can be used. The way in which the queries are structured and managed can depend on the nature of the particular source. If the source provides a programmatic API, then the queries can be formulated and managed, and the results returned, according to that API. In this instance, because Craig's List does not provide a programmatic API, the system 100 first scrapes the Missed Connections forum for posts, and load them into a searchable database. To generate a script, the system 100 then formulates and executes queries against this database.

Again, in terms of this example, those queries are first looking for content including such terms as “coffee shop”; then for terms associated with the morning commute (e.g., “Red line,” “El,” etc.); then “health club”; terms such as “dinner,” “restaurant,” etc.; and finally terms such as “bar,” “club,” dancing,” etc. Each of these sample term sets is intended to reflect venues associated with the particular time of day relevant to a portion of the narrative structure, and is intended to retrieve content concerning or mentioning such venues. Results from each query are collected, and then filtered, for example for appropriate length. One quote is then selected for each type of venue/time of day. Finally, the system 100 can query Yelp via its API for reviews of the specific venues identified in the selected quotes, or failing that, for venues of that type, and a highly ranked and positive review of appropriate length can be selected.

The resulting script, including a selection from Missed Connections, alternating with a related selection from Yelp, organized according to venue/time of day, and potentially increasing in sexual content, can then be presented to the actors in real time, for delivery to the audience.

The system 100 can also form queries to identify relevant visual (or even audio) content online, again, e.g., using terms associated with the “current” venue, which is presented to the audience on screen (or via speakers) as a backdrop to the actors' performances, and updated automatically as appropriate as the scene progresses.

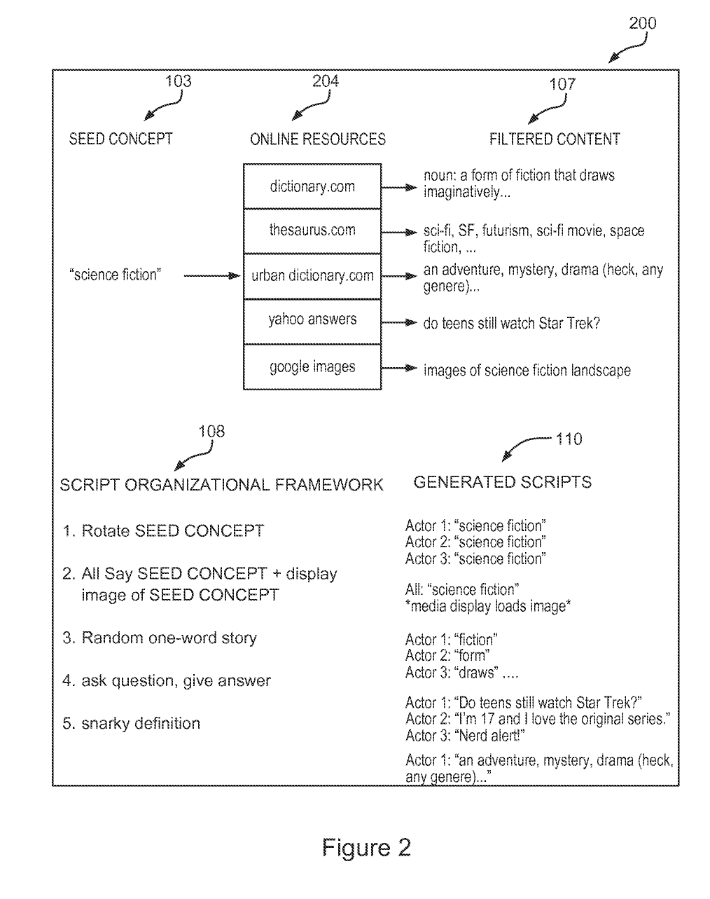

FIG. 2 is a block diagram of an example flow logic 200 of the system architecture of FIG. 1. The seed concept 103, e.g., science fiction, can be fed to online resources 204, e.g., dictionary.com, thesaurus.com, Urban Dictionary, YAHOO! Answers, and/or GOOGLE images, etc., to product filtered content 107. For example, from dictionary.com, “noun: a form of fiction that draws imaginatively . . . ”, or from thesaurus.com, “sci-fi, SF, futurism, sci-fi movie, space fiction, . . . ”, or from urban dictionary, “an adventure, mystery, drama (heck, any genre) . . . ”, or from YAHOO! Answers, “do teens still watch Star Trek”, or from GOOGLE images, an image of a science fiction landscape, etc. The system 100 can process the filtered content 107 through the script organizational framework 108 to produce a generated script 110.

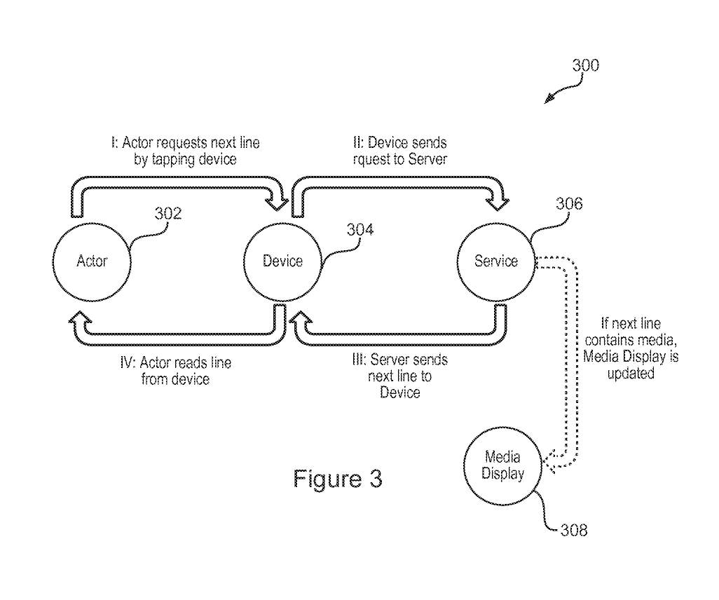

FIG. 3 is a flow diagram of an example presentation mechanism 300. The presentation mechanism 300 can include a client-server architecture. As described above, lines can be presented to the actors 302 for delivery to the audience immediately upon their generation by the system 100; or they can be compiled into a script that is then presented to the actors in real time for delivery to the audience. If the actors have no way to control timing (e.g., to indicate that they have delivered the current line and need their next line), for example, if the lines are presented to the actors via large monitors, then a single client device 304 receives the lines from the server 306. This client device 304 is under the control of a director or stage manager, who determines when the actors need their lines, and indicate via the client device that the next line or lines are displayed on the monitor(s) for presentation to the actors 302.

Alternatively, actors 302 in a real-time performance wears the device 304, e.g., Google Glass or similar personal information delivery devices, which allows them to directly control the presentation of their lines in real time as they require them for delivery to the audience. While a wearable device may be preferable, any personal information delivery device, e.g., a “smart” cell phone, a tablet, a personal computer, a laptop, etc., may be used. These devices display the actors' current lines, as well as cues and directions.

The external server 306 can be tasked with sending the appropriate lines to each actor 302 upon request. The actor 302, upon delivering their current line, requests their next line, e.g., by tapping the device 304. This sends a request for presentation of the next line from the device 304 to the server 306. The request contains metadata pertaining to the current state of the performance, including identifiers for the specific actor, and indicators of position in the current performance or script, e.g., of the recently delivered line, and of the next line. Using this metadata, the server responds to the request with the appropriate information, including the line to be presented, cues, and other possible directions.

Generated scripts may also include instructions for displaying multimedia content to the audience (images, videos, text, etc.) through visual media displays 308 connected to a web page hosted by the server 306. These displays 308 are updated by the server 306 with the correct media content as the script progresses. Example results can be seen below. The Google Glass device displays three prompts: a cue consisting of the line to be read by the preceding actor (actor 1 in this case); the line to be delivered by the current actor; and a direction to tap to receive the current actor's next line.

Actor 1: .... a computer generated theatrical experience.
Everything you see tonight will be automatically generated or
curated by a computer.

*Tap For Next Line*

In some cases, as shown below, the current actor's line may be too long to display on a single page. As before, the actor 302 receives a cue (again the preceding actor's line). The first portion of the current line is then shown, followed by a prompt to tap for the remainder of the line. Script generation identifies long lines and ensures that no words are “chopped off” when such lines are partitioned.

Actor 1: ....Teens don't like Star Trek: The Original Series?
I'm 17 and I love the original star trek series. I think it's the
best trek series and probably one of the greatest shows ever
put on television. I even have a t shirt of the original series All
my friends....

*Tap For More*

....of the original series All my friends
laugh at me for it, they think it's so old and lame but it isn't, it's
a timeless classic that will never be outdated or old fashioned.

*Tap For Next Line*

The systems and methods described above may be implemented in many different ways in many different combinations of hardware, software firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various embodiments have been described, it can be apparent that many more embodiments and implementations are possible. Accordingly, the embodiments are not to be restricted.

What is claimed is:

1. A method for constructing scripts, comprising:
executing, with a processor, queries against a source to identify material based on terms;
filtering results of the queries based on pragmatic features;
selecting the material based on the filtered queries; and
generating a script based on the selected material.

2. The method of claim 1, where the source comprises an online source.

3. The method of claim 1, further comprising ranking the results of the queries and selecting the material based on the ranked results.

4. The method of claim 1, further comprising presenting the material to actors in real time for presentation to an audience while a dialog for the script is being generated.

5. The method of claim 1, further comprising caching the material before presentation of the script to the audience.

6. The method of claim 1, further comprising parameterizing the queries.

7. The method of claim 6, where parameterizing the queries comprises obtaining parameters including at least one of themes, topical terms, concepts, tonalities, locations, locales, and content extracted from material returned by previously executed queries.

8. The method of claim 1, where the pragmatic feature comprises at least one of a length of the material, a level of positive or negative sentiment of the material, a level of profanity of the material, and a level of personal content of the material.

9. The method of claim 8, further comprising determining the level of personal content by a prevalence of personal pronouns and relationship terms.

10. The method of claim 1, further comprising modulating a level of the pragmatic features throughout the script.

11. The method of claim 1, further comprising ordering the material based on at least one of narrative structure and a script organizational framework.

12. The method of claim 11, where the narrative structure comprises organizing the material by at least one of reference to venues and common occurrences in a time period or event.

13. The method of claim 1, further comprising editing the material by changing at least one of place names, proper names, gender, deleting or inserting profanity, replacing terms with synonyms, and editing for length.

14. A system for constructing scripts, comprising:
a processor providing a query of a source to determine material;
a filter to provide a filtered content from the material based on a pragmatic feature; and
the processor to generate a script based on the filtered content.

15. The system of claim 14, where the processor ranks the results of the queries and selects the material based on the ranked results.

16. The system of claim 14, where the processor presents the material to actors in real time for presentation to an audience while a dialog of the script is being generated.

17. The system of claim 14, where the processor parameterizes the queries, where parameterizing the queries comprises obtaining parameters including at least one of themes, topical terms, concepts, tonalities, locations, locales, and content extracted from material returned by previously executed queries.

18. The system of claim 14, where the pragmatic feature comprises at least one of a length of the material, a level of positive or negative sentiment of the material, a level of profanity of the material, and a level of personal content of the material.

19. The system of claim 14, further comprising a media display to display the script.

20. The system of claim 19, where the media display comprises at least one of a call phone and a wearable device.
